(19) United States
(12) Patent Application Publication
(10) Pub. No.: US 2014/0350933 A1
(43) Pub. Date: Nov. 27, 2014

(54) VOICE RECOGNITION APPARATUS AND CONTROL METHOD THEREOF

(71) Applicant: SAMSUNG ELECTRONICS CO., LTD., Suwon-si (KR)

(72) Inventors: Eun-sang BAK, Ansan-si (KR); Kyung-duk KIM, Suwon-si (KR); Hyung-jong NOH, Suwon-si (KR); Seong-han RYU, Seoul (KR); Geun-bae LEE, Seoul (KR)

(73) Assignee: SAMSUNG ELECTRONICS CO., LTD., Suwon-si (KR)

(21) Appl. No.: 14/287,718

(22) Filed: May 27, 2014

Related U.S. Application Data
(60) Provisional application No. 61/827,099, filed on May 24, 2013.

(30) Foreign Application Priority Data
Feb. 19, 2014 (KR) 10-2014-0019030

(51) Int. Cl. G10L 15/18

(52) U.S. Cl. CPC G10L 15/1822
USPC 704/249

(57) ABSTRACT

A voice recognition apparatus includes: an extractor configured to extract utterance elements from a user's uttered voice; an LSP converter configured to convert the extracted utterance elements into LSP formats; and a controller configured to determine whether an utterance element related to an OOV exists among the utterance elements converted into the LSP formats with reference to vocabulary list information including pre-registered vocabularies, and to determine an OOD area in which it is impossible to provide response information in response to the uttered voice, in response to determining that the utterance element related to the OOV exists. Accordingly, the voice recognition apparatus provides appropriate response information according to a user's intent by considering a variety of utterances and possibilities regarding a user's uttered voice.

### CROSS-REFERENCE TO RELATED APPLICATIONS

This application claims priority from U.S. Provisional Application No. 61/827,099, filed on May 24, 2013, in the United States Patent and Trademark Office, and Korean Patent Application No. 10-2014-0019030, filed on Feb. 19, 2014, in the Korean Intellectual Property Office, the disclosures of which are incorporated herein by reference in their entireties.

### BACKGROUND

Apparatuses and methods consistent with exemplary embodiments relate to a voice recognition apparatus and a control method thereof, and more particularly, to a voice recognition apparatus which provides response information corresponding to a user's uttered voice, and a control method thereof.

A voice recognition apparatus receives the user's uttered voice, analyzes the uttered voice, determines a domain which may be relevant to the user's utterance, and provides information in response to the user's utterance based on the determined domain.

However, various domains and services that may be provided as corresponding to the user's utterance have recently become available, making a determination of the user's intent more complicated. Thus, the related art voice recognition apparatus may inaccurately determine a domain which is not intended by the user and may provide information in response to the user's uttered voice based on the incorrect domain.

For example, when an uttered voice “Is there any action movie to watch?” is received from the user, a television (TV) program domain and a Video On Demand (VOD) domain may correspond to the uttered voice. However, the related art voice recognition apparatus is not capable of considering multiple domains and arbitrarily detects only one domain, even when other domains may be applicable. Further, the above example of the uttered voice may include a user intent on an action movie provided by a TV program, i.e., the uttered voice may correspond to the TV program domain. However, the related art voice recognition apparatus does not analyze a user's true intent from the uttered voice and may arbitrarily determine a different domain, for example, the VOD domain, regardless of the user's intent and may provide response information based on the VOD domain.

Additionally, the related art voice recognition apparatus determines a domain for providing information in response to the user's uttered voice based on a specific utterance element extracted from the uttered voice. For example, a user's uttered voice “Find me an action movie later!” indicates that the user's search intent is for the action movie in the future rather than in the present. However, the related art voice recognition apparatus does not determine the domain for providing information in response to the user's uttered voice based on all of the utterance elements extracted from the uttered voice, i.e., only based on a specific utterance element, and, thus, may inaccurately provide a result of searching for an action movie which is playing in the present, based on the determined domain.

Because the related art voice recognition apparatus may provide response information irrespective of a user's intent, the user's utterance needs to be more exact in order to receive response information as intended, which is difficult and time consuming and may cause inconvenience to the user.

### SUMMARY

Exemplary embodiments may address at least the above problems and/or disadvantages and other disadvantages not described above. However, it is understood that one or more exemplary embodiment are not required to overcome the disadvantages described above, and may not overcome any of the problems described above.

One or more exemplary embodiments provide appropriate response information according to a user's intention by considering a variety of cases regarding a user's uttered voice in a voice recognition apparatus of an interactive system.

According to an aspect of an exemplary embodiment, there is provided a voice recognition apparatus including: an extractor configured to extract at least one utterance element from a user's uttered voice; a lexico-semantic pattern (LSP) converter configured to convert the at least one extracted utterance element into an LSP format; and a controller configured to, in response to presence of an utterance element related to an Out Of Vocabulary (OOV) among the utterance elements converted into the LSP formats with reference to vocabulary list information including a plurality of pre-registered vocabularies, determine an Out Of Domain (OOD) area in which it is impossible to provide response information in response to the uttered voice.

The controller may determine at least one utterance element having nothing to do with the plurality of vocabularies included in the vocabulary list information among the utterance elements converted into the LSP formats, as the utterance element of the OOV.

The vocabulary list information may further include a reliability value which is set based on a frequency of use of each of the plurality of vocabularies, and the controller may determine an utterance element related to a vocabulary having a reliability value less than a predetermined threshold value among the utterance elements converted into the LSP formats with reference to the vocabulary list information, as the utterance element of the OOV.

In response to absence of the utterance element related to the OOV among the utterance elements converted into the LSP formats, the controller may determine a domain for providing response information in response to the uttered voice based on the utterance element converted into the LSP format.

In response to an extended domain related to the utterance element converted into the LSP format being detected based on a predetermined hierarchical domain model, the controller may determine at least one candidate domain related to the extended domain as a final domain, and, in response to the extended domain not being detected, the controller may determine a candidate domain related to the utterance element converted into the LSP format as a final domain.

The hierarchical domain model may include: a candidate domain of a lowest concept which matches with a main act corresponding to a first utterance element indicating an executing instruction among the utterance elements converted into the LSP formats, and a parameter corresponding to a second utterance element indicating an object; and a virtual extended domain which is a superordinate concept of the candidate domain.

The voice recognition apparatus may further include a communicator configured to communicate with a display apparatus. In response to an OOD area being determined in relation to the uttered voice, the controller may transmit a response information-untransmittable message to the display apparatus, and, in response to a final domain related to the uttered voice being determined, the controller may generate response information regarding the uttered voice on the domain determined as the final domain, and may control the communicator to transmit the response information to the display apparatus.

According to an aspect of another exemplary embodiment, there is provided a control method of a voice recognition apparatus, the method including: converting the at least one extracted utterance element into an LSP format; determining whether there is an utterance element related to an OOV among the utterance elements converted into the LSP formats with reference to vocabulary list information including a plurality of pre-registered vocabularies; and, in response to presence of the utterance element related to the OOV among the utterance elements converted into the LSP formats, determining an OOD area in which it is impossible to provide response information in response to the uttered voice.

The determining may include determining at least one utterance element having nothing to do with the plurality of vocabularies included in the vocabulary list information among the utterance elements converted into the LSP formats, as the utterance element of the OOV.

The vocabulary list information may further include a reliability value which is set based on a frequency of use of each of the plurality of vocabularies, and the determining may include determining an utterance element related to a vocabulary having a reliability value less than a predetermined threshold value among the utterance elements converted into the LSP formats with reference to the vocabulary list information, as the utterance element of the OOV.

The method may further include, in response to absence of the utterance element related to the OOV among the utterance elements converted into the LSP formats, determining a domain for providing response information in response to the uttered voice based on the utterance element converted into the LSP format.

The determining the domain may include, in response to an extended domain related to the utterance element converted into the LSP format being detected based on a predetermined hierarchical domain model, determining at least one candidate domain related to the extended domain as a final domain, and in response to the extended domain not being detected, determining a candidate domain related to the utterance element converted into the LSP format as a final domain.

The hierarchical domain model may include: a candidate domain of a lowest concept which matches with a main act corresponding to a first utterance element indicating an executing instruction among the utterance elements converted into the LSP formats, and a parameter corresponding to a second utterance element indicating an object; and a virtual extended domain which is a superordinate concept of the candidate domain.

The method may further include: in response to an OOD area being determined in relation to the uttered voice, transmitting a response information-untransmittable message to the display apparatus, and, in response to a final domain related to the uttered voice being determined, generating response information regarding the uttered voice on the domain determined as the final domain, and transmitting the response information to the display apparatus.

### BRIEF DESCRIPTION OF THE DRAWINGS

The above and/or other aspects will be more apparent by describing in detail certain exemplary embodiments, with reference to the accompanying drawings, in which:

FIG. 1 is a view illustrating an example of an interactive system according to an exemplary embodiment;

FIG. 2 is a block diagram of a voice recognition apparatus according to an exemplary embodiment;

FIG. 3 is a view to illustrate a method for determining a domain and a dialogue frame for providing response information in response to a user's uttered voice according to an exemplary embodiment;

FIG. 4 is a view to illustrate a method for determining a state in which it is impossible to provide response information in response to a user's uttered voice according to an exemplary embodiment;

FIG. 5 is a view illustrating an example of a hierarchical domain model according to an exemplary embodiment; and

FIG. 6 is a flowchart illustrating a control method for providing response information corresponding to a user's uttered voice according to an exemplary embodiment.

### DETAILED DESCRIPTION

Certain exemplary embodiments are described in greater detail below with reference to the accompanying drawings.

In the following description, same reference numerals are used for the same elements when they are depicted in different drawings. The matters defined in the description, such as detailed construction and elements, are provided to assist in a comprehensive understanding of exemplary embodiments. Thus, it is apparent that exemplary embodiments can be carried out without those specifically defined matters. Also, functions or elements known in the related art are not described in detail since they would obscure the exemplary embodiments with unnecessary detail.

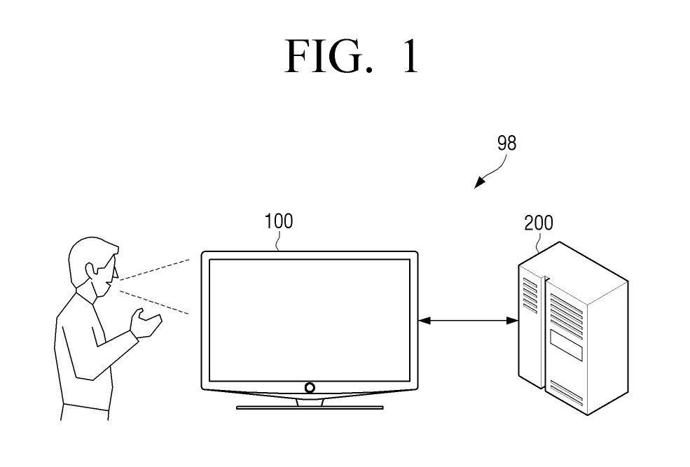

FIG. 1 is a view illustrating an example of an interactive system according to an exemplary embodiment.

As shown in FIG. 1, the interactive system 98 includes a display apparatus 100 and a voice recognition apparatus 200. The voice recognition apparatus 200 receives a user's uttered voice signal from the display apparatus 100 and determines what domain the user's uttered voice belongs to. Thereafter, the voice recognition apparatus 200 generates response information regarding the user's uttered voice based on a dialogue pattern on a determined final domain and transmits the response information to the display apparatus 100.

The display apparatus 100 may be a smart TV. However, this is merely an example and the display apparatus 100 may be implemented by using a variety of electronic devices such as a mobile phone, e.g., a smartphone, a desktop personal computer (PC), a notebook PC, a navigation device, etc. The display apparatus 100 may collect the user's uttered voice and transmit the uttered voice to the voice recognition apparatus 200. The voice recognition apparatus 200 determines the final domain that the user's uttered voice received from the display apparatus 100 belongs to, generates response information regarding the user's uttered voice based on the dialogue pattern on the final domain, and transmits the response information to the display apparatus 100. The display apparatus 100 may output the response information received from the voice recognition apparatus 200 through a speaker or may display the response information on a screen.

Specifically, in response to the user's uttered voice being received from the display apparatus 100, the voice recognition apparatus 200 extracts at least one utterance element from the uttered voice. Thereafter, the voice recognition apparatus 200 determines whether there is an utterance element related to an Out Of Vocabulary (OOV) among the extracted utterance elements with reference to vocabulary list information including a plurality of vocabularies already registered based on utterance elements extracted from previously uttered voice signals. In response to the presence of the utterance element related to the OOV among the extracted utterance elements, the voice recognition apparatus 200 determines that the user's uttered voice contains an Out Of Domain (OOD) area for which it is impossible to provide response information in response to the uttered voice. In response to determining the OOD area in which it is impossible to provide the response information in response to the uttered voice, the voice recognition apparatus 200 transmits a response information-untransmittable message for informing that the response information cannot be provided in response to the uttered voice to the display apparatus 100.

In response to determining that there is no utterance element related to the OOV among the extracted utterance elements, the voice recognition apparatus 200 determines a domain for providing response information in response to the user's uttered voice based on the utterance elements extracted from the uttered voice, generates the response information regarding the user's uttered voice based on the determined domain and transmits the response information to the display apparatus 100.

As described above, the interactive system 98 according to exemplary embodiments determines the domain for providing the response information in response to the user's uttered voice or determines the OOD area according to whether there is the utterance element related to the OOV based on the utterance elements extracted from the user's uttered voice, and provides a result of the determining. Accordingly, the interactive system can minimize an error by which the response information irrelevant to a user's intent is provided to user, unlike the related art.

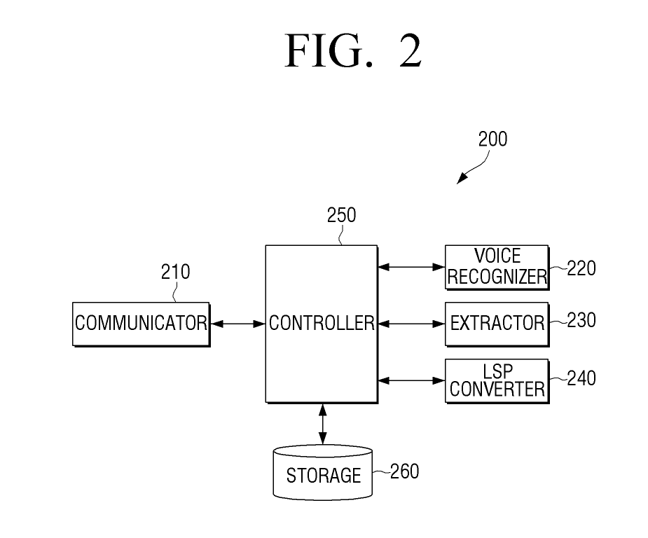

FIG. 2 is a block diagram illustrating a voice recognition apparatus according to an exemplary embodiment.

As shown in FIG. 2, the voice recognition apparatus 200 includes a communicator 210, a voice recognizer 220, an extractor 230, a lexico-semantic pattern (LSP) converter 240, a controller 250, and a storage 260.

The communicator 210 communicates with the display apparatus 100 to receive a user's uttered voice collected by the display apparatus 100. The communicator 210 may generate response information corresponding to the user's uttered voice received from the display apparatus 100 and may transmit the response information to the display apparatus 100. The response information may include information on a content requested by the user, a result of keyword searching, and information on a control command of the display apparatus 100.

The communicator 210 may include at least one of a short-range wireless communication module (not shown), a wireless communication module (not shown), etc. The short-range wireless communication module is a module for communicating with an external device located at a short distance according to a short-range wireless communication scheme such as Bluetooth, Zigbee, etc. The wireless communication module is a module which is connected to an external network and communicates according to a wireless communication protocol such as WiFi, IEEE, etc. The wireless communication module may further include a mobile communication module for accessing a mobile communication network and communicating according to various mobile communication standards such as 3^{rd} Generation (3G), 3^{rd} Generation Partnership Project (3GPP), Long Term Evolution (LTE), etc.

The communicator 210 may communicate with a web server (not shown) via the Internet to receive response information (a result of web surfing) regarding the user's uttered voice, and may transmit the response information to the display apparatus 100.

The voice recognizer 220 recognizes the user's uttered voice received from the display apparatus 100 via the communicator 210 and converts the uttered voice into a text. According to an exemplary embodiment, the voice recognizer 220 may convert the user's uttered voice into the text by using a Speech To Text (STT) algorithm. However, this is not limiting and the voice recognition apparatus 200 may receive a user's uttered voice which has been converted into a text from the display apparatus 100 via the communicator 210 and the voice recognizer 220 may be omitted.

In response to the user's uttered voice being converted into the text by the voice recognizer 220 or the uttered voice converted into the text being received from the display apparatus 100 via the communicator 210, the extractor 230 extracts at least one utterance element from the user's uttered voice which has been converted into the text.

Specifically, the extractor 230 may extract the utterance element from the text which has been converted from the user's uttered voice based on a corpus table pre-stored in the storage 260. The utterance element refers to a keyword for performing an operation requested by the user in the user's uttered voice and may be divided into a first utterance element which indicates an executing instruction (user action) and a second utterance element which indicates a main feature, that is, an object. For example, in the case of a user's uttered voice “Find me an action movie!”, the extractor 130 may extract the first utterance element indicating the executing instruction “Find”, and the second utterance element indicating the object “action movie”.

The LSP converter 240 converts the utterance element extracted by the extractor 230 into an LSP format. In the above-described example, in response to the first utterance element indicating the executing instruction “Find” and the second utterance element indicating the object “action movie” being extracted from the user's uttered voice “Find me an action movie!”, the LSP converter 240 may convert the first utterance element indicating the execution instruction “Find” into an LSP format “% search”, and may convert the second utterance element indicating the object “action movie” into an LSP format “@ genre”.

The controller 250 determines whether there is an utterance element related to an OOV among the utterance elements, which have been converted into the LSP formats through the LSP converter 240, with reference to vocabulary list information pre-stored in the storage 260. In response to the presence of the utterance element related to the OOV, the controller 250 determines an OOD area in which it is impossible to provide response information in response to the user's uttered voice. The vocabulary list information may include a plurality of vocabularies which have been already registered in relation to utterance elements extracted from previously uttered voices of a plurality of users, and reliability values which are set based on a frequency of use of each of the plurality of vocabularies.

According to an exemplary embodiment, the controller 250 may determine an utterance element having nothing to do with the plurality of vocabularies among the utterance elements converted into the LSP formats, as the utterance element of the OOV, with reference to the plurality of vocabularies included in the vocabulary list information.

According to another exemplary embodiment, the controller 250 may determine an utterance element related to a vocabulary having a reliability value less than a predetermined threshold value among the utterance elements converted into the LSP formats, as the utterance element of the OOV, with reference to the vocabulary list information. For example, from the uttered voice “Find me an action movie tomorrow!”, utterance elements “action movie”, “tomorrow”, and “Find me” may be extracted, and each utterance element may be converted into an LSP format. Among the utterance elements which have been converted into the LSP formats, a vocabulary related to the utterance element “tomorrow” may already be registered at the vocabulary list information and a reliability value of the corresponding vocabulary may be 10. When the reliability value of the vocabulary related to the utterance element “tomorrow” among the utterance elements converted into the LSP formats is less than a predetermined threshold value, the controller 250 may determine the utterance element “tomorrow” among the utterance elements converted into the LSP formats as the utterance element of the OOV.

As described above, in response to determining that there is the utterance element related to the OOV among the utterance elements extracted from the user's uttered voice and converted into the LSP formats, the controller 250 may determine that it is impossible to determine a domain for providing the response information in response to the user's uttered voice. The controller 250 may determine the OOD area in which it is impossible to provide the response information in response to the user's uttered voice. In response to determining the OOD area, the controller 250 may transmit a response information-untransmittable message informing that it is impossible to provide the response information in response to the uttered voice to the display apparatus 100 via the communicator 210.

In response to determining that there is no utterance element related to the OOV among the utterance elements converted into the LSP formats, the controller 250 may determine a domain for providing the response information in response to the uttered voice based on the utterance element converted into the LSP format and a dialogue frame for providing the response information in response to the uttered voice on the determined domain. Thereafter, the controller 250 generates the response information regarding the dialogue frame and transmits the response information to the display apparatus 100 via the communicator 210.

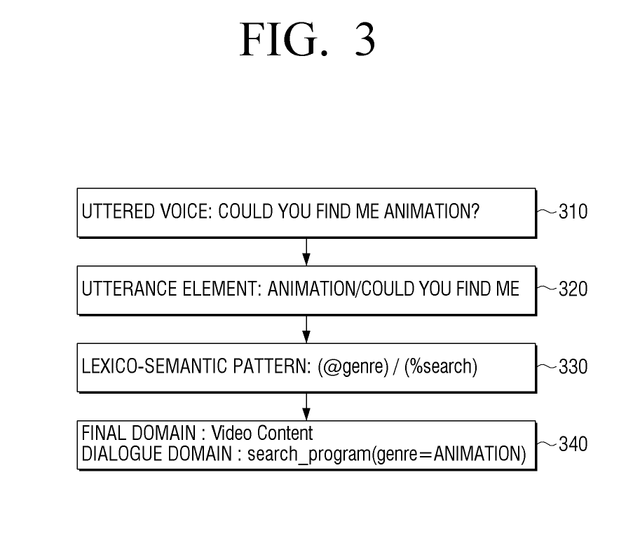

FIG. 3 is a view illustrating an operation of determining a domain and a dialogue frame for providing response information in response to a user's uttered voice in a voice recognition apparatus according an exemplary embodiment.

In operation 310, an uttered voice “Could you find me an animation?” is received from the display apparatus 100. The voice recognition apparatus 200 extracts utterance elements “animation” and “could you find me” from the uttered voice (operation 320). Among the extracted utterance elements, the utterance element “could you find me” may be an utterance element indicating an executing instruction, and the utterance element “animation” may be an utterance element indicating an object. In response to such utterance elements being extracted, the voice recognition apparatus 200 may convert the utterance elements “animation” and “could you find me” into lexico-semantic pattern formats “@genre” and “% search”, respectively, through the LSP converter 220 (operation 330).

In response to the utterance elements extracted from the uttered voice being converted into the LSP formats, the voice recognition apparatus 200 determines a final domain and a dialogue frame for providing the response information in response to the user's uttered voice based on the utterance elements converted into the LSP formats (operation 340). That is, the voice recognition apparatus 200 may determine a final domain “Video Content” based on the utterance elements converted into the LSP formats, and may determine a dialogue frame “search_program (genre=animation)” on the final domain “Video Content”. The final domain “Video Content” is an extended domain which is detected based on a predetermined hierarchical domain model. In response to determining the extended domain “Video Content” as the final domain, the voice recognition apparatus 200 may provide the response information in response to the user's uttered voice based on the dialogue frame “search_program (genre=animation)” on domains “TV Program” and “VOD” which are subordinate to the extended domain “Video Content”. Such a hierarchical domain model will be explained in detail below.

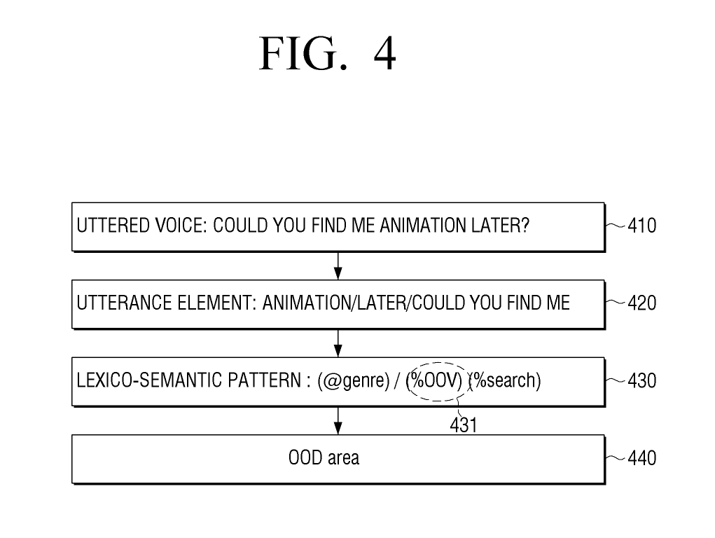

FIG. 4 is a view illustrating an operation of determining a state in which it is impossible to provide response information in response to a user's uttered voice in the voice recognition apparatus according to an exemplary embodiment.

In operation 410, an uttered “Could you find me an animation later?” is received from the display apparatus 100. The voice recognition apparatus 200 extracts utterance elements “animation”, “later”, and could you find me” from the uttered voice (operation 420). In response the utterance elements being extracted, the voice recognition apparatus 200 converts the utterance elements “animation”, “later”, and “could you find me” into LSP formats “@ genre”, “% OOV”, and “% search”, respectively, through the LSP converter 220 (operation 430). The % OOV (reference numeral 431) which is the LSP format converted from the utterance element “later” may indicate that a vocabulary related to the utterance element “later” is not registered at vocabulary list information including a plurality of pre-registered vocabularies or that a reliability value according to a frequency of use is less than a predetermined threshold value.

Accordingly, in response to the LSP “% OOV” indicating that there is the utterance element related to the OOV, the voice recognition apparatus 200 determines that it is impossible to determine a domain for providing the response information in response to the user's uttered voice. The voice recognition apparatus 200 determines the domain area regarding the user's uttered voice as an OOD area in which it is impossible to provide the response information (operation 440).

In response to determining the OOD area, the voice recognition apparatus 200 transmits a response information-untransmittable message informing that it is impossible to provide the response information in response to the uttered voice to the display apparatus 100 via the communicator 210. The display apparatus 100 displays the response information-untransmittable message received from the voice recognition apparatus 200 on the screen, and, in response to such a message being displayed, the user may re-utter to receive response information regarding the user's uttered voice via the voice recognition apparatus 200.

In response to determining that there is no utterance element related to the OOV among the utterance elements converted into the LSP formats, the controller 250 may determine the domain related to the utterance elements based on a predetermined hierarchical domain model. The predetermined hierarchical domain model may be a hierarchical model including a candidate domain of a lowest concept and a virtual extended domain which is set as a superordinate concept of the candidate domain, as described in a greater detail below.

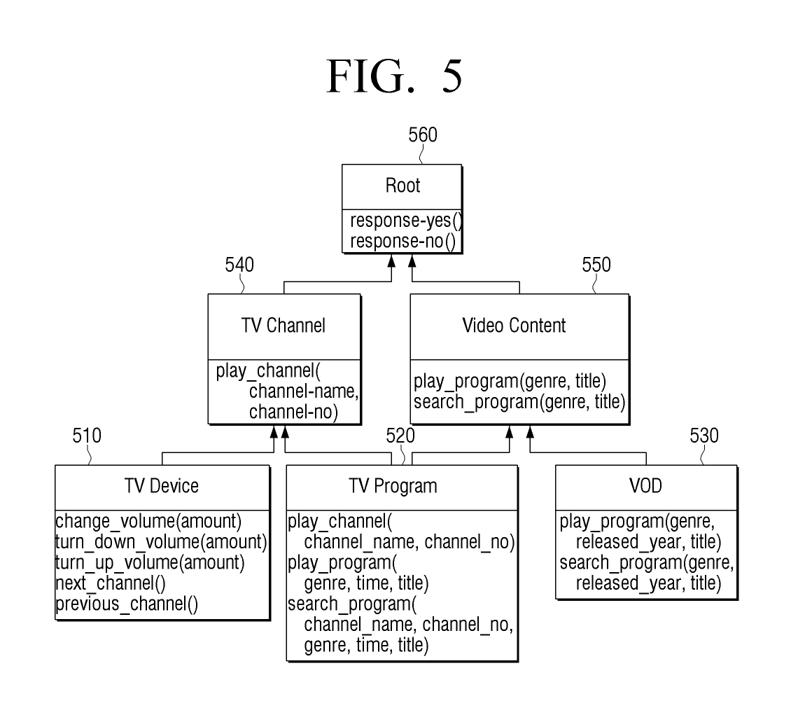

FIG. 5 is a view illustrating an example of a hierarchical domain model according to an exemplary embodiment.

As shown in FIG. 5, a lowest layer of the hierarchical domain model may set candidate domains TV device 510, TV program 520, and VOD 530. The candidate domain includes a main act corresponding to a first utterance element indicating an executing instruction, and a dialogue frame related to a second utterance element indicating an object from the utterance elements converted into the LSP formats.

An intermediate layer may set a first extended domain TV channel 540, which is an intermediate concept of the candidate domains TV Device 510 and TV Program 520, and a second extended domain Video Content 550, which is an intermediate concept of the candidate domains TV Program 520 and VOD 530. In addition, a highest layer may set a root extended domain 560, which is a highest concept of the first and second extended domains TV channel 540 and Video Content 550.

That is, the lowest layer of the hierarchical domain model may set the candidate domain for determining a domain area for generating response information in response to the uttered voices of users, and the intermediate layer may set the extended domain of the intermediate concept including at least two candidate domains of the lowest concept. The highest layer may set the extended domain of the highest concept including all of the candidate domains set as the lower concept. Each domain set in each layer may include a dialogue frame for providing response information in response to the user's uttered voice on each domain.

For example, the candidate domain TV program 520, which is set in the lowest layer, may include dialogue frames “play_channel (channel_name, channel_no),” “play_program (genre, time, title),” and “search_program (channel_name, channel_no, genre, time, title).” The second extended domain Video Content 550 including the candidate domain TV program 520 may include dialogue frames “play_program (genre, title)” and “search_program (genre, title).”

Accordingly, in response to the utterance elements extracted from the uttered voice “Could you find me an animation?” being converted into the LSP formats “@ genre” and “% search”, the controller 250 generates a dialogue frame “search_program (genre=animation)” based on the utterance elements converted into the LSP formats. Thereafter, the controller 250 detects a domain that the dialogue frame “search_program (genre=animation)” belongs to with reference to the dialogue frames included in each domain in each layer of the predetermined hierarchical domain model. That is, the controller 250 may detect the extended domain “Video Content 550” that the dialogue frame “search_program (genre=animation)” belongs to with reference to the dialogue frames included in each domain in each layer. In response to the second extended domain Video Content 550 being detected, the controller 250 determines that the candidate domains related to the extended domain Video Content 550 are the TV Program 520 and the VOD 530, and determines the candidate domains TV Program 520 and VOD 530 as final domains. Thereafter, the controller 250 searches for an animation based on the dialogue frame “search_program (genre=animation) which has been already generated based on the utterance elements converted into the LSP formats “@ genre” and “% search” on the determined final domains, i.e., TV Program 520 and VOD 530. Thereafter, the controller 250 generates response information a result of the search and transmits the response information to the display apparatus 100 via the communicator 210.

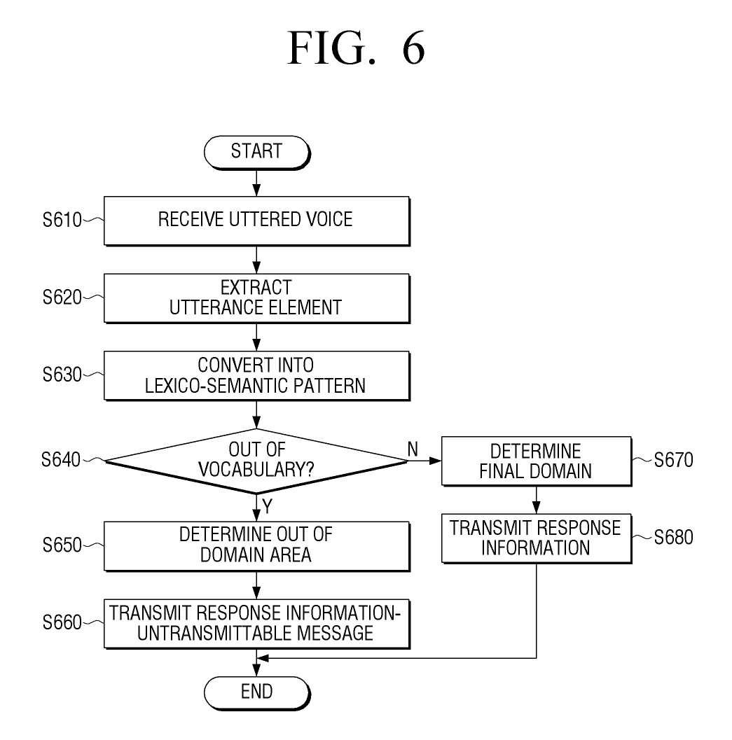

FIG. 6 is a flowchart illustrating a control method for providing response information corresponding to a user's uttered voice in the voice recognition apparatus of the interactive system according to an exemplary embodiment. The detailed operation of the voice recognition apparatus 200 is described above with reference to FIG. 2 and, thus, the repeated descriptions are omitted below.

As shown in FIG. 6, the voice recognition apparatus 200 receives a user's uttered voice from the display apparatus 100 (operation S610). In response to the user's uttered voice being received, the voice recognition apparatus 200 may convert the user's uttered voice into a text by using an STT algorithm. However, this is not limiting and the voice recognition apparatus 200 may receive an uttered voice which has been into a text from the display apparatus 100. In response to the uttered voice being converted into the text or the uttered voice converted into the text being received, the voice recognition apparatus 200 extracts at least one utterance element from the user's uttered voice which has been converted into the text (operation S620).

Specifically, the voice recognition apparatus 200 may extract at least one utterance element from the uttered voice which has been converted into the text based on a pre-stored corpus table

In response to the utterance element being extracted, the voice recognition apparatus 200 converts the utterance element extracted from the uttered voice into an LSP format (operation S630).

Thereafter, the voice recognition apparatus 200 determines whether there is an utterance element related to an OOV among the utterance elements which have been converted into the LSP formats with reference to pre-stored vocabulary list information (operation S640).

According to an exemplary embodiment, the voice recognition apparatus 200 may determine an utterance element having nothing to do with the plurality of vocabularies among the utterance elements converted into the LSP format, as the utterance element of the OOV, with reference to the plurality of vocabularies included in the vocabulary list information.

According to another exemplary embodiment, the voice recognition apparatus 200 may determine an utterance element related to a vocabulary having a reliability value less than a predetermined threshold value among the utterance elements converted into the LSP format, as the utterance element of the OOV, with reference to the vocabulary list information.

In response to determining that there is the utterance element related to the OOV among the utterance elements converted into the LSP formats, the voice recognition apparatus 200 determines an OOD area in which it is impossible to provide the response information in response to the user's uttered voice, and transmits a response information-untransmittable message informing that it is impossible to provide the response information in response to the uttered voice to the display apparatus 100 (operations S650 and S660).

In response to determining that there is no utterance element related to the OOV among the utterance elements converted into the LSP formats in operation S640, the voice recognition apparatus 250 determines a domain for providing the response information in response to the uttered voice based on the utterance element converted into the LSP format (operation S670).

The voice recognition apparatus 200 may determine the domain related to the utterance element converted into the LSP format based on a predetermined hierarchical domain model. The predetermined hierarchical domain model may be a hierarchical model including a candidate domain of a lowest concept and a virtual extended domain which is set as a superordinate concept of the candidate domain. The candidate domain includes a main act corresponding to the first utterance element indicating the executing instruction, and a dialogue frame related to the second utterance element indicating the object among the utterance elements converted into the LSP formats.

The voice recognition apparatus 200 may determine whether the extended domain related to the utterance element converted into the LSP format is detected or not based on the predetermined hierarchical domain model, and, in response to the extended domain being detected, the voice recognition apparatus 200 may determine at least one candidate domain related to the extended domain as a final domain. In response to the extended domain not being detected, the voice recognition apparatus 200 may determine the candidate domain related to the utterance element converted into the LSP format as the final domain.

In response to the final domain for providing the response information in response to the uttered voice being determined, the voice recognition apparatus 200 determines a dialogue frame for providing the response information in response to the user's uttered voice on the final domain, and generates the response information regarding the dialogue frame and transmits the response information to the display apparatus 100 (operation S680).

The method for providing the response information in response to the user's uttered voice in the voice recognition apparatus according to the various exemplary embodiments may be implemented by using a program code and may be stored in various non-transitory computer-readable media to be provided to each server or device.

The non-transitory computer-readable medium refers to a medium that stores data semi-permanently rather than storing data for a very short time, such as a register, a cache, and a memory, and is readable by an apparatus. Specifically, the above-described various applications or programs may be stored in the non-transitory readable medium such as a compact disc (CD), a digital versatile disk (DVD), a hard disk, a Blu-ray disk, a USB, a memory card, a ROM, etc., and may be provided.

The foregoing exemplary embodiments and advantages are merely exemplary and are not to be construed as limiting. The exemplary embodiments can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A voice recognition apparatus comprising a processor comprising:
an extractor configured to extract utterance elements from an uttered voice of a user;
a lexico-semantic pattern (LSP) converter configured to convert the extracted utterance elements into LSP formats; and
a controller configured to determine whether an utterance element related to an Out Of Vocabulary (OOV) exists among the utterance elements converted into the LSP formats with reference to vocabulary list information comprising pre-registered vocabularies, and to determine an Out Of Domain (OOD) area in which it is impossible to provide response information in response to the uttered voice, in response to determining that the utterance element related to the OOV exists.

2. The voice recognition apparatus of claim 1, wherein the controller is configured to determine the utterance element, among the utterance elements converted into the LSP formats, which is absent from the pre-registered vocabularies, as the utterance element of the OOV.

3. The voice recognition apparatus of claim 1, wherein the vocabulary list information further comprises reliability values which are set based on a frequency of use of respective pre-registered vocabularies, and
the controller is configured to determine the utterance element, among the utterance elements converted into the LSP formats, which is related to a respective pre-registered vocabulary having a reliability value less than a threshold value, as the utterance element of the OOV.

4. The voice recognition apparatus of claim 1, wherein the controller is configured to determine a final domain for providing response information in response to the uttered voice based on the utterance elements converted into the LSP formats, in response to an absence of the utterance element related to the OOV from the utterance elements converted into the LSP formats.

5. The voice recognition apparatus of claim 4, wherein the controller is configured to determine whether an extended domain, which is a higher level domain of a hierarchical domain model and relates to the utterance elements converted into the LSP formats, is present, determine a candidate domain which is a lower level domain of the hierarchical domain model and relates to the extended domain, as the final domain, in response to the extended domain being present, and determine the candidate domain of the lower level related to the utterance elements converted into the LSP formats, as the final domain, in response to the extended domain being absent.

6. The voice recognition apparatus of claim 5, wherein the candidate domain of the hierarchical domain model is a domain of a lowest concept which matches with a main act corresponding to a first utterance element indicating an executing instruction, and a parameter corresponding to a second utterance element indicating an object, among the utterance elements converted into the LSP formats, and
the extended domain of the hierarchical domain is a virtual extended domain which is a superordinate concept of the candidate domain.

7. The voice recognition apparatus of claim 4, further comprising a communicator configured to communicate with a display apparatus,
wherein the controller is configured to transmit a response information informing about a untransmittable message, to the display apparatus, in response to the OOD area being determined, generate the response information regarding the uttered voice based on the domain determined as the final domain, and control the communicator to transmit the response information to the display apparatus.

8. A voice recognition method performed by a processor, the method comprising:
extracting utterance elements from an uttered voice of a user;
converting the extracted utterance elements into lexico-semantic pattern (LSP) formats;
determining whether an utterance element related to an Out Of Vocabulary (OOV) exists among the utterance elements converted into the LSP formats with reference to vocabulary list information comprising pre-registered vocabularies; and
determining an Out Of Domain (OOD) area in which it is impossible to provide response information in response to the uttered voice, in response to determining that the utterance element related to the OOV exists.

9. The method of claim 8, wherein the determining whether the utterance element related to the OOV exists comprises:
determining the utterance element, among the utterance elements converted into the LSP formats, which is absent in the pre-registered vocabularies, as the utterance element of the OOV.

10. The method of claim 8, wherein the vocabulary list information further comprises reliability values which are set based on a frequency of use of respective pre-registered vocabularies, and the determining whether the utterance element related to the OOV exists comprises:
determining the utterance element, among the utterance elements converted into the LSP formats, which is related to a respective pre-registered vocabulary having a reliability value less than a threshold value, as the utterance element of the OOV.

11. The method of claim 8, further comprising:
determining a final domain for providing response information in response to the uttered voice based on the utterance elements converted into the LSP formats, in response to an absence of the utterance element related to the OOV among the utterance elements converted into the LSP formats.

12. The method of claim 11, wherein the determining the final domain comprises:
determining whether an extended domain, which is a domain of a higher level of a hierarchical domain model and relates to the utterance elements converted into the LSP formats, is present;
determining a candidate domain, which is a domain of a lower level of the hierarchical domain model and relates to the extended domain, as the final domain, in response to the extended domain being present, and
determining the candidate domain of the lower level which relates to the utterance elements converted into the LSP formats, as the final domain, in response to the extended domain being absent.

13. The method of claim 12, wherein the candidate domain of the hierarchical domain model is a domain of a lowest concept which matches with a main act corresponding to a first utterance element indicating an executing instruction, and a parameter corresponding to a second utterance element indicating an object from among the utterance elements converted into the LSP formats, and
the extended domain of the hierarchical domain model is a virtual extended domain which is a superordinate concept of the candidate domain.

14. The method of claim 11, further comprising:
transmitting a response information informing of a untransmittable message to a display, in response to the OOD area being present in the uttered voice, and
generating the response information regarding the uttered voice based on the final domain and transmitting the response information to the display, in response to the final domain being determined.

15. A voice recognition apparatus comprising:
a display; and
a processor which is configured to determine whether voice of a user contains words which are non-matchable to content providing domains by:
extracting utterance elements from the voice;
converting the extracted utterance elements into lexico-semantic pattern (LSP) formats;
determining a presence of an Out Of Vocabulary (OOV) utterance element, among the converted utterance elements, based on pre-registered vocabularies;
determining that the voice contains an Out Of Domain (OOD) area which is non-matchable with the content providing domains, in response to the presence of the OOV utterance element; and
providing a message informing the user of the non-matchable word present in the voice of the user.

16. The voice recognition apparatus of claim 15, wherein the processor is further configured to determine the presence of the OOV utterance element in response to the converted utterance element being absent in the pre-registered vocabularies or in response to the converted utterance element being present in one of the pre-registered vocabularies and having been assigned a reliability value lower than a threshold.

17. The voice recognition apparatus of claim 15, wherein the processor is further configured to determine a final content providing domain corresponding to the voice from the converted utterance elements, in response to an absence of the OOV utterance element, by matching the converted utterance elements to the available content providing domains.

18. The voice recognition apparatus of claim 17, wherein the content providing domains comprise at least one of a television (TV) channel, a TV program, and a video on demand (VOD).
